(19) United States
(12) Patent Application Publication
(10) Pub. No.: US 2026/0261405 A1
(43) Pub. Date: Sep. 3, 2026

(54) Secure Exchange Secret

(71) Applicant: Apple Inc., Cupertino, CA (US)

(72) Inventors: Peter Chang, Santa Clara, CA (US); Thomas P. Mensch, Sunnyvale, CA (US); Chandan K. Benjaram, Santa Clara, CA (US); Wade Benson, Sunnyvale, CA (US); Rejeesh Kaippara Ravindran, San Jose, CA (US)

(21) Appl. No.: 19/451,648

(22) Filed: Jan. 16, 2026

Related U.S. Application Data
(60) Provisional application No. 63/765,118, filed on Feb. 28, 2025.

(51) Int. Cl. H04L 9/08; H04L 9/32

(52) U.S. Cl. CPC H04L 9/0838; H04L 9/3263

(57) ABSTRACT

Techniques are disclosed relating to securely provisioning key material used to establish an authenticated communication. In some embodiments, a computing device includes a cryptographic circuit coupled to a secure memory inaccessible to a processor of the computing device. The cryptographic circuit is configured to derive a shared secret using key material maintained in the secure memory. A wireless radio circuit of the computing device is configured to repeatedly listen for a wireless communication including the shared secret. The computing device then performs one or more actions in response to the wireless radio circuit detecting the wireless communication including the shared secret. In some embodiments, the wireless radio circuit listens for the wireless communication while the processor is in a reduced power state and, in response to detecting the shared secret in the wireless communication, causes the processor to exit the reduced power state.

The present application claims priority to U.S. Prov. Appl. No. 63/765,118, entitled “Secure Exchange Secret,” filed February 28, 2025, which is incorporated by reference herein in its entirety.

### BACKGROUND

### Technical Field

This disclosure relates generally to computer security, and, more specifically, to authenticating a wireless communication for various purposes.

### Description of the Related Art

Developers periodically release software updates to enhance the performance, functionality, and security of their applications and devices. These updates can be beneficial for users, as they often introduce new features and improvements that enhance the overall user experience. For instance, updates may add compatibility with the latest hardware, refine user interfaces for better usability, add new desired functionality, or improve the software for faster performance. More importantly, software updates can play a significant role in maintaining security. They frequently include patches that address vulnerabilities and flaws that could be exploited by malicious actors through malware, viruses, and unauthorized access. Regularly updating software can effectively plug gaps that malicious actors could exploit to access sensitive data, thus protecting users from cyber threats by keeping their systems up-to-date with the latest security measures.

### BRIEF DESCRIPTION OF THE DRAWINGS

FIG. 1 is a block diagram illustrating an example of a computing system configured to authenticate a wireless communication with a shared secret.

FIGS. 2A and 2B are communication diagrams illustrating an example of a registration exchange between a device and an initiating system.

FIG. 3 is a block diagram illustrating an example of components within an initiating system communicating with a device.

FIG. 4 is a block diagram illustrating an example of a secure enclave processor including cryptographic circuitry configured to facilitate authentication of the wireless communication with the shared secret.

FIG. 5 is a block diagram illustrating an example of cryptographic circuitry including a secure memory that stores private key material.

FIGS. 6A and 6B are flow diagrams illustrating examples of methods for implementing a wireless communication with a shared secret.

FIG. 7 is a block diagram illustrating an example computing device implementing functionality described herein.

FIG. 8 is a diagram illustrating example applications for systems and devices implementing functionality described herein.

FIG. 9 is a block diagram illustrating an example computer-readable medium that stores circuit design information for implementing devices having functionality described herein.

### DETAILED DESCRIPTION

Updating software on computing devices, such as smartphones, tablets, etc., typically requires user interaction and an active network connection. However, there are scenarios where it is beneficial for a computing device to be updated before it is actively set up by a user, such as when it is still sealed in packaging and awaiting distribution or sale. In such cases, the device may not have been associated with a user, configured for network connectivity, or granted permissions to communicate with an update server. Additionally, devices are likely turned off while in storage, limiting their ability to actively check for updates. Without an effective way to apply updates (or provoke other actions) before user activation, devices may ship with outdated software, security vulnerabilities, or compatibility issues that could impact their functionality upon first use.

The inventors have recognized that it would be desirable to provoke a computing device to perform various actions (e.g., installing software updates) while it is in, for example, a packaged state—and before any user has been associated with the device. As will be discussed in greater detail below, in some embodiments, a computing device is configured to monitor for a wireless communication that can be authenticated using a previously established shared secret. If this wireless communication is detected, the computing device can awake from a low power state and perform one or more requested actions. In order to prevent an unauthorized actor from producing the wireless communication, the computing device includes a cryptographic circuit coupled to a secure memory, which may be accessible only by the cryptographic circuit, in some embodiments. The secure memory stores key material, which may be generated and stored during manufacturing of the computing device. The cryptographic circuit may then derive the shared secret for authenticating a subsequently received wireless communication. The cryptographic circuit may provide this shared secret to a wireless radio in the computing device that, then, repeatedly listens for the wireless communication. In response to detecting the wireless communication, the computing device can perform one or more actions, such as downloading and installing a software update from an external system. The use of a secure cryptographic circuit and corresponding secure memory can make it more difficult to extract key material used to derive the shared secret for some nefarious use and ensures that only an authorized entity (e.g., a device manufacturer) can provoke activation of a device to perform some action.

By using the techniques described herein, the security and reliability of a computing device can be improved by enabling, for example, installation of software updates before a device is unboxed—and without further requiring setup steps such as Wi-Fi configuration, user authentication, or a persistent network connection. Furthermore, in some embodiments, the radio used to monitor for the particular wireless communication can be a low-power wireless radio (e.g., a Bluetooth^{®} Low Energy (BLE)), which can enable the device to periodically listen (e.g., once every ten minutes) for particular communications while other components of the device remain powered off—extending battery life during storage. Thus, when a user does eventually purchase and activate their device, it is already running the most up-to-date and secure software version, reducing the risk of early-stage security vulnerabilities, compatibility issues, or out-of-date firmware.

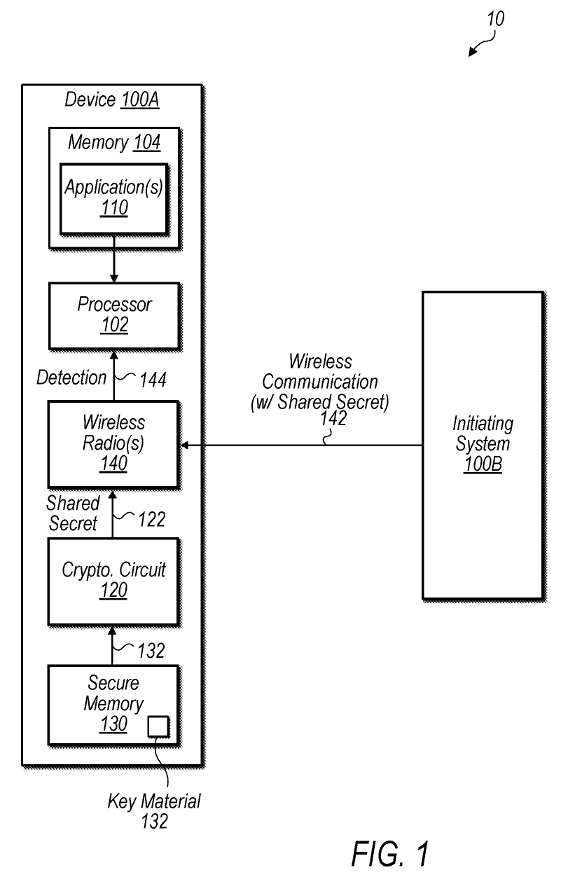

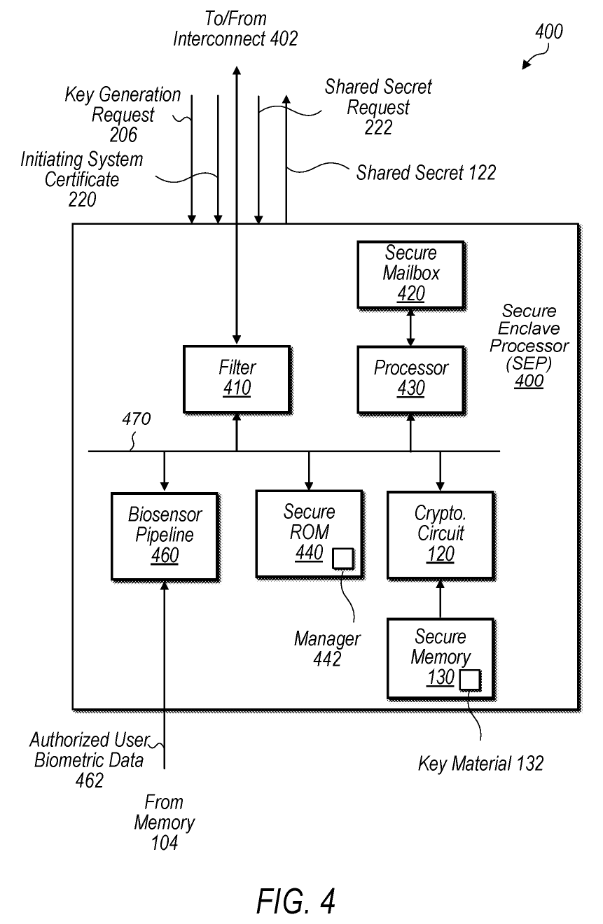

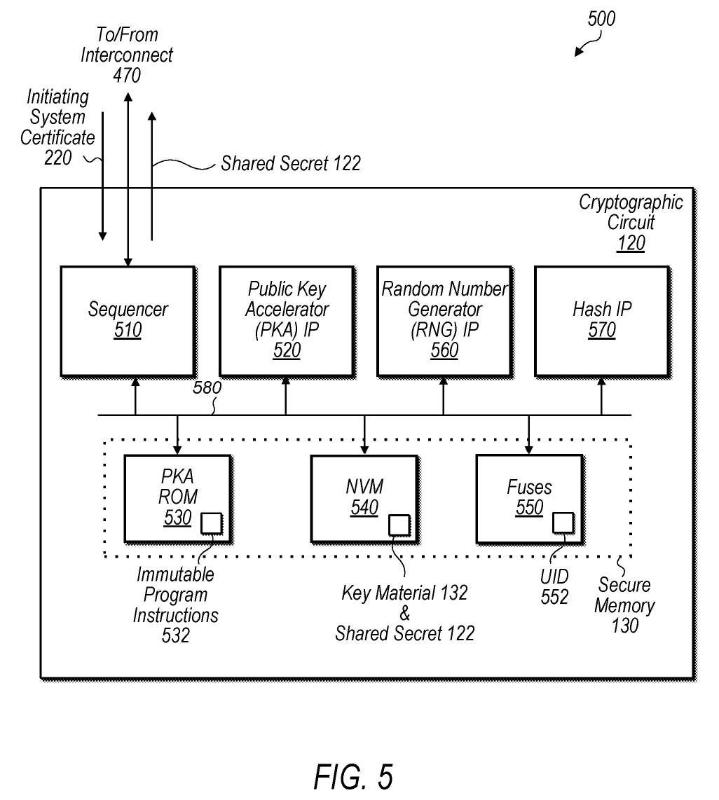

Turning now to FIG. 1, a block diagram of a wireless communication system 10 is depicted. In the illustrated embodiment, system 10 includes a computing device 100A (e.g., a smartphone, computer system, etc.), which includes a processor 102, memory 104, a cryptographic circuit 120, secure memory 130 (coupled to cryptographic circuit 120), and one or more wireless radio(s) 140. Memory 104 includes one or more applications 110 while secure memory 130 includes key material 132. System 10 further includes an initiating system 100B. In some embodiments, system 10 may be implemented differently than shown (e.g., computing devices 100A and computing system 100B may include one or more components discussed below with respect to FIGS. 4-5).

Computing device 100A is representative of a device that cannot easily be accessed by a person wanting to perform some action with device 100A. As noted above, in some embodiments, device 100A is sealed within a package, which may be sitting on the shelf of a retail store awaiting purchase, sitting in a warehouse awaiting distribution, etc. In other embodiments, device 100A lacks a user interface (or supports a limited user interface) that makes interaction with the device difficult. In still other embodiments, device 100A may merely be placed in a location that is difficult for a person access. Furthermore, in some instances (such as when sealed in a package), device 100A may be placed in a lower power state to conserve its limited battery supply. This lower power state may include, for example, powering off the display, processor 102, one or more of wireless radios 140 (e.g., those supporting cellular or Wi-Fi connectivity), etc.—and may result in the device appearing powered off to anyone observing device 100A. When in this lower power state, however, it may be desirable to provoke device 100A to perform one or more actions, which may require execution of program instructions such as application 110.

Applications 110, in various embodiments, are a set of program instructions stored in memory 104 and executable by processor 102, to facilitate one or more requested actions. As suggested above, application 110 may include a software installer executable to contact an external server, download a software update, and install the update on device 100A. In some embodiments, device 100A supports a feature in which an application 110 contacts an external server to download a message for presentation to a user upon unboxing of device 100A. For example, a person may purchase device 100A as a gift for someone else and want to present a message on unboxing to that person such as a message wishing them a happy birthday. Other actions may include device 100A reporting information about itself such as battery level, device identification information, supported features, etc., which may be helpful for a retailer trying to assess current inventory levels. Applications 110 may also include firmware, drivers, etc. used to set up a network stack for device 100A including wireless communication establishment, authentication, and cryptographic operations, etc. Because processor 102 may initially be powered off, in some embodiments, processor 102 is unable to execute instructions of applications 110 to perform these actions. Device 100A, however, may rely on one or more of wireless radios 140 to monitor for a particular wireless communication 142 in order to cause device 100 to exit its low power state—and thus awaken processor 102 (as well as any other needed hardware components).

Wireless radios 140 may support any suitable protocol to enable wireless communication with device 100A such as BLE, Wi-Fi, cellular, etc. In the illustrated embodiment, at least one of wireless radios 140 is configured to repeatedly listen for a particular wireless communication 142 from an initiating system 100B. For example, the wireless radio 140 may be configured to awake every ten minutes to listen of a wireless communication 142 before returning to a reduced power state. Furthermore, the particular radio 140 may be a lower power radio than other radios 140 such as the BLE radio 140 (as opposed to the Wi-Fi radio 140), which may be monitoring for a BLE beacon implementing wireless communication 142. In response to detection of this wireless communication 142, the wireless radio 140 may generating a detection signal 144 to trigger an awaking of device 100A including processor 102 to cause further operations such as initiating execution of one or more of applications 110. This awaking may also include awaking other powered-off hardware such as a Wi-Fi radio 140 to facilitate subsequent communications for device 100A in performing one or more requested actions. To prevent any system from triggering this awaking functionality, the wireless radio 140 authenticates the wireless communication 142 using a shared secret 122, which may be included in communication 142, used to encrypt communication 142, used to sign communication 142, or used in some other manner to authenticate communication 142. To further prevent potential exploit of this monitoring functionality, device 100A does not, in the illustrated embodiment, rely on programming instructions executing on processor 102 to derive (or otherwise handle) shared secret 122 and, instead, relies on cryptographic circuit 120 to generate shared secret 122 using key material 132 stored in a secure memory 130 inaccessible to processor 102 in order to prevent processor 102 from ever being able to access shared secret 122. Thus, even if a malicious actor is able to compromise software being executed by processor 102, this malicious actor is not able to easily access shared secret 122 or key material 132.

Cryptographic circuit 120 is a secure circuit configured to perform cryptographic operations, including key generation as well as encryption and decryption using keys, which may be stored in secure memory 130 (or stored externally in a protected manner). As used herein, the term “secure circuit” refers to a circuit that protects an isolated, internal resource from being directly accessed by an external circuit such as processor 102. This internal resource may be memory that stores sensitive data such as personal information (e.g., biometric information, credit card information, etc.), encryptions keys, random number generator seeds, etc. This internal resource may also be circuitry that performs services/operations associated with sensitive data such as encryption, decryption, generation and verification of digital signatures, etc. Cryptographic circuit 120 may implement any suitable cryptographic algorithm such as Data Encryption Standard (DES), Advanced Encryption Standard (AES), Rivest Shamir Adleman (RSA), Digital Signature Algorithm (DSA), etc. In some embodiments, circuit 120 may further implement elliptic curve cryptography (ECC). As will be discussed with FIG. 4, cryptograph circuit 120 and a secure memory 130 may be included within a secure enclave processor (SEP) that uses one or more techniques to further isolate access to cryptographic circuit 120 and secure memory 130.

Secure memory 130 is a memory circuit configured to store data in a way that is inaccessible to processor 102. Secure memory 130 may be a local memory (e.g., internal memory of circuit 120 or SEP 400 discussed below) configured to store key data, which may include key material 132, shared secret 122, etc. In some embodiments, secure memory 130 may be configured such that only cryptographic circuit 120 is able to read and write data to secure memory 130. Accordingly, while an application running on processor 102 may be able to request performance of an action (e.g., derivation of secret 122) with respect to data in secure memory 130, processor 102 may not be able to read or write data to secure memory 130 as memory 130 may, for example, lack the physical read and write interfaces to facilitate such actions for processor 102. In some embodiments, cryptographic circuit 120 may access other forms of storage, which may include non-volatile storages such as discussed below with respect to FIG. 5. In some embodiments, these other storages may also include a set of fuses that are burnt during a fabrication in order to record, for example, a portion of key material 132. In some embodiments, to expand its available storage, keys generated by cryptographic circuit 120 may be stored externally of memory 130 but encrypted using one or more keys stored only in secure memory 130. Exemplary components of secure memory 130 will be discussed in more detail with respect to FIG. 5.

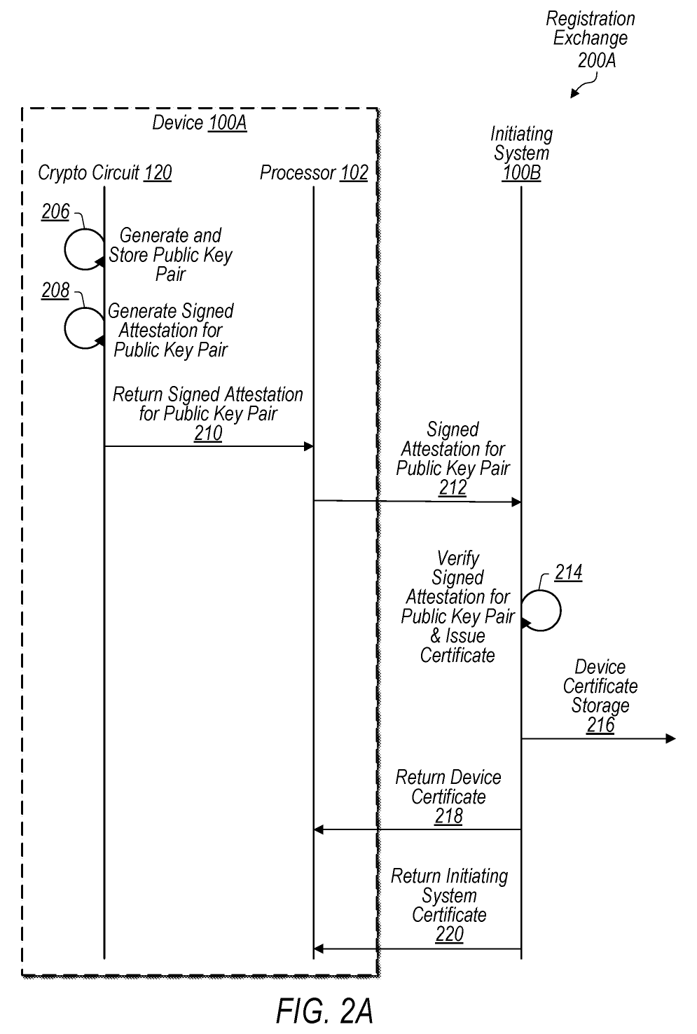

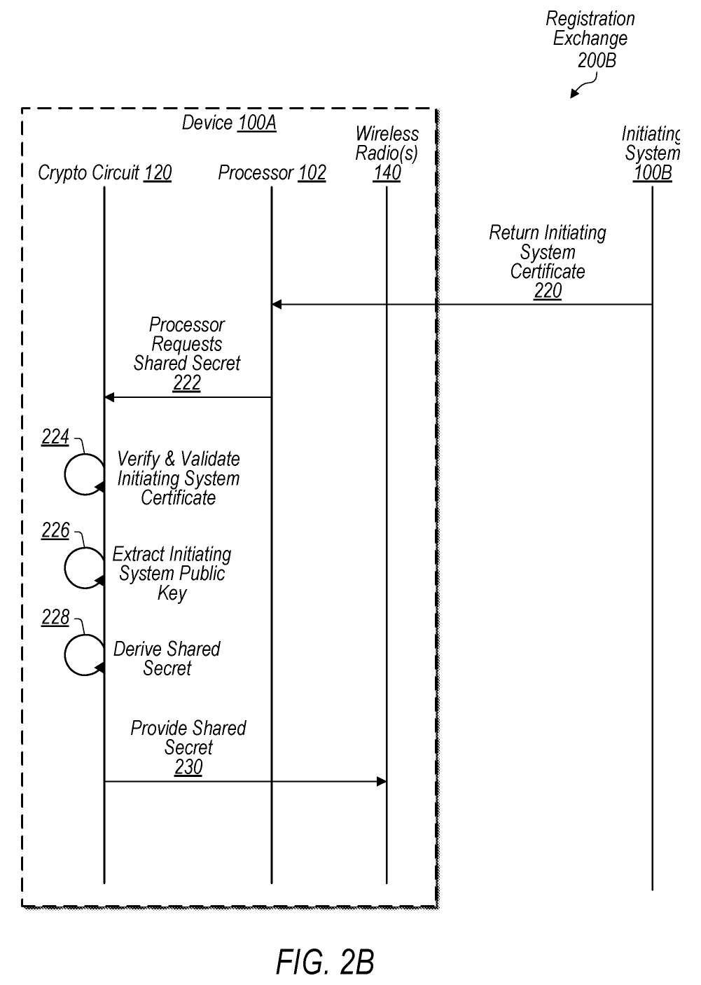

In various embodiments, cryptographic circuit 120 is configured to generate a shared secret 122 and provide it directly to a wireless radio 140 to enable it to begin monitoring for a wireless communication 142. Cryptographic circuit 120 may derive shared secret 122 using any suitable technique. For example, key material 132 may include one or more of an initialization vector (IV), seed data, a salt value, etc., which may be input into a key derivation function (KDF) implemented by cryptographic circuit 120 to generate shared secret 122. Key material 132 may include a password, which may be used as an input into a password-authenticated key exchange (PAKE) implemented by cryptographic circuit 120 to generate shared secret 122. In some embodiments, shared secret 122 is generated using a Diffie-Hellman (DH) key exchange, such as Elliptic-curve Diffie-Hellman (ECDH), implemented by cryptographic circuit 120 in which key material 132 includes a private key of a public-key pair. For example, as will be discussed next with FIGS. 2A and 2B, cryptographic circuit 120 may generate a public-private key pair and securely store the private key in secure memory 130. Initiating system 100B may generate its own public-key pair. Then, both device 100A and initiating system 100B may exchange their respective public keys. Using its private key and the received public key, cryptographic circuit 120 can then generate shared secret 122. Once shared secret 122 is derived, cryptographic circuit 120 securely transfers it to wireless radio(s) 140, allowing wireless radio(s) 140 to use the shared secret for use in authenticating wireless communications 142. In some embodiments, wireless radio(s) 140 may further encrypt (or authenticate) subsequent communications using shared secret 122, such as those used to performed particular actions noted herein.

In various embodiments, device 100A implements the monitoring/listening techniques described herein until one or more conditions are satisfied and then discontinues listening for wireless communications 142. For example, because device 100A may be battery powered, one of these conditions may include device 100A discontinuing monitoring in response to a batter level dropping below a predetermined threshold—e.g., to avoid shortening the life of the battery. As another condition, device 100A may discontinue listening for communications 142 once a user has been associated with device 100A. Accordingly, while device 100A may be sitting in a box awaiting purchase (i.e., does not yet have an owner), device 100A may monitor for a wireless communication 142 to provoke some action. Once a user has purchased device 100A and set up a corresponding user account on device 100A, however, device 100A does not monitor for communications 142. In other words, the monitoring/listening techniques described herein are not some mechanism to push updates to a user’s device without their authorization. Other conditions may include other constraints such as only monitoring for a month after device fabrication, only monitoring during particular time intervals, only monitoring when device is at a particular location, etc.

Turning now to FIG. 2A, a communication diagram of a registration exchange 200A between device 100A and initiating system 100B is depicted. In the illustrated embodiment, registration exchange 200A is in an initial portion of a registration exchange that establishes cryptographic trust between device 100A and initiating system 100B to facilitate derivation of shared secret 122 in a subsequent portion of the exchange discussed later with FIG. 2B.

The registration exchange 200A process begins, at step 206, where cryptographic circuit 120 generates and stores an initial public key pair. In the illustrated embodiment, the private key of this key pair is securely stored by cryptographic circuit 120 as key material 132 (or, at least, a portion of key material 132) and later used to derive its copy of shared secret 122. As previously noted, keeping the private key secured within secure memory 130 and cryptographic circuit 120 ensures that it cannot be extracted or misused, reinforcing the integrity of future cryptographic operations. Once the public key pair has been generated, cryptographic circuit 120 generates a signed attestation for the public key pair at step 208 in order to attest to the validity of this newly generated key pair. The attestation may include metadata such as device-specific information, the generated public key, and a digital signature from cryptographic circuit 120 confirming its authenticity. In some embodiments, this attestation is implemented as a certificate signing request (CSR), which may be x.509 compliant. The digital signature included in this attestation may also be created using a signing key stored within secure memory 130 and used by cryptographic circuit 120, which may ensure that only device 100A can generate valid attestations. In some embodiments, this signing key is part of another public key pair that is registered beforehand during fabrication of device 100A in order to attest to subsequently generated key pairs associated with specific purposes such as the key pair generated at 206 for deriving shared secret 122.

At step 210, the signed attestation for the public key pair is provided by cryptographic circuit 120 to processor 102, which handles communication with initiating system 100B. By isolating cryptographic operations within cryptographic circuit 120, device 100A reduces the risk of exposing sensitive key material 132 to potential threats such as compromised software running on processor 102.

At step 212, processor 102 transmits the signed attestation for the public key pair to initiating system 100B. Upon receiving the signed attestation, initiating system 100B begins the verification and certificate issuance process at step 214. During this step, initiating system 100B verifies the signed attestation by checking the included digital signature applied by cryptographic circuit 120. If the verification is successful, initiating system 100B (or certificate authority (CA) associated with system 100B) issues a corresponding certificate certifying that the public key belongs to device 100A. In some embodiments, this certificate is also x.509 compliant.

Afterwards, initiating system 100B stores this device certificate at step 216 in order to enable subsequent access to the included public key for derivation of shared secret 122. This may include storing the device certificate in one or more locations such as a local certificate database on initiating system 100B, a cloud-based storage, or a hardware security module (HSM) that protects cryptographic credentials from unauthorized access, etc.

At step 218, initiating system 100B transmits the device certificate back to processor 102 within device 100A in order to confirm that the public key of device 100A has been successfully registered and can now be used for subsequent communications in which device 100A may authenticate using its device certificate.

At step 220, initiating system 100B transmits an initiating system certificate to device 100A. This initiating system certificate contains a public key of initiating system 100B, which is associated with a corresponding private key of initiating system 100B. Once device 100A is in possession of this initiating-system certificate and initiating system 100B is in possession of the device certificate, device 100A and system 100B are now in possession of one another’s public keys allowing them to derive respective copies of shared secret 112 as will be discussed next.

Turning now to FIG. 2B, a communication diagram of a registration exchange 200B between device 100A and initiating system 100B is depicted. In the illustrated embodiment, registration exchange 200B begins with the final step of FIG. 2A (e.g., registration system 200B is a continuation of registration exchange 200A for the complete registration exchange 200), where initiating system 100B returns an initiating system certificate to device 100A (specifically processor 102 in the illustrated embodiment) at step 220.

At step 222, processor 102 sends a request to establish a shared secret 122 to cryptographic circuit 120. As part of sending this shared secret request, processor 102 also provides cryptographic circuit 120 with the initiating system certificate received from initiating system 100B.

At step 224, cryptographic circuit 120 validates the initiating system certificate to confirm its authenticity. This process may involve checking the digital signature applied to the certificate, ensuring that the certificate was issued by a trusted authority and has not been altered. By verifying the initiating system certificate, cryptographic circuit 120 ensures that device 100A does not accept a communication from a malicious or untrusted entity attempting to manipulate device 100A. Following validation, at step 226, cryptographic circuit 120 extracts the initiating system public key embedded within the initiating system certificate. At step 228, cryptographic circuit 120 derives shared secret 122 using the initiating system public key and its own previously generated private key. This operation may use ECDH or some other form of a key exchange (or key encapsulation mechanism (KEM)). Although not shown, initiating system 100B may perform the same operation using its private key and device 100A’s public key obtained from the earlier stored device certificate in order to derive its own instance of shared secret 122 to be included in a subsequent communication 142.

At step 230, once the shared secret 122 is derived, cryptographic circuit 120 provides the shared secret 122 to a wireless radio 140. Once completed, the wireless radio 140 may begin monitoring for a communication 142 to provoke it to wake up and perform some action.

Although not shown, in some embodiments, device 100A and initiating system 100B may subsequently use the initiating system certificate and the device certificate for various purposes other than merely deriving shared secret. For example, in some embodiments, device 100A and system 100B may exchange certificates at a later point to establish a secure communication session between themselves such as establishing a transport layer security (TLS) session to securely exchange data to facilitate the various actions noted herein.

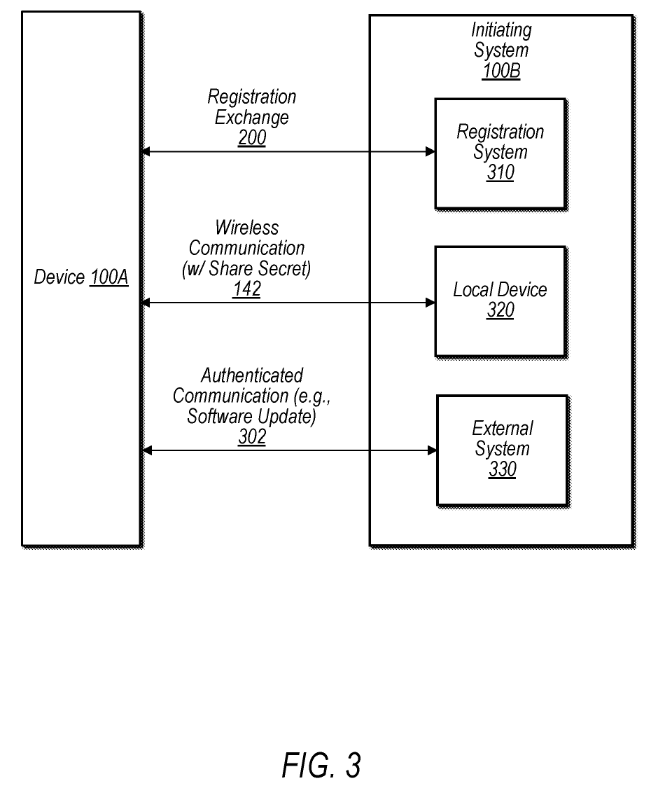

Turning now to FIG. 3, a block diagram of components within initiating system 100B is depicted. In the illustrated embodiment, initiating system 100B includes multiple components that interact with device 100A at different stages of operation. Specifically, initiating system 100B includes registration system 310, local device 320, and external system 330. These components may facilitate the registration exchange, wireless communication, and authenticated interactions between device 100A and initiating system 100B, supporting operations such as secure provisioning, software updates, and messaging.

At the initial stage of communication, registration system 310 interacts with device 100A via registration exchange 200, as indicated by the bi-directional arrow between these components. This process may correspond to registration exchanges 200A and 200B discussed with respect to FIGS. 2A and 2B, where device 100A generates a public key pair, receives a corresponding certificate, and used to later establish a shared secret 122. In some embodiments, registration system 310 may be implemented by a set of servers located at a manufacturing facility, which assign cryptographic credentials to newly fabricated devices before they are deployed to users. By performing this registration exchange, device 100A establishes an initial cryptographic trust with initiating system 100B, ensuring that future communications can be securely authenticated.

Following the registration exchange, device 100A engages in wireless communication 142 including shared secret 122 with local device 320. In some embodiments, local device 320 may be a computer, a technician’s workstation, or another provisioning device that interacts with device 100A. For example, a technician at a retail store may use local device 320 to communicate with device 100A using Bluetooth^{®} or another short-range wireless protocol. The shared secret established during registration exchange 200 enables local device 320 to securely authenticate itself to device 100A, ensuring that only authorized provisioning devices can initiate a communication 142. By leveraging wireless communication 142, local device 320 may perform a variety of functions, such as triggering an initial setup process, transmitting provisioning data, or facilitating a software update request.

Device 100A may also communicate with another external system 330 via an authenticated communication 302, which may be provoked by the reception of communication 142 from local device 320. Examples of external system 330 may include, but are not limited to, a remote server, a cloud-based service, or an enterprise backend system. In some embodiments, authenticated communication 302 may involve the transmission of software updates, security patches, or user notifications, ensuring that device 100A remains up to date and compliant with security policies. For instance, if device 100A is still in its packaging at a distribution center, authenticated communication 302 may allow it to receive a firmware update or an activation message before it is delivered to a customer. Similarly, if device 100A is deployed in a retail setting, authenticated communication 302 may enable device 100A to securely retrieve device enrollment credentials, carrier provisioning data, or application settings from a centralized server.

Turning now to FIG. 4, a block diagram of secure enclave processor (SEP) 400 is depicted. In the illustrated embodiment, SEP 400 includes a filter 410, secure mailbox mechanism 420, processor 430, secure ROM 440, cryptographic circuit 120, secure memory 130, and a biosensor pipeline 460 coupled together via an interconnect 470. In some embodiments, SEP 400 may include more (or less) components than shown in FIG. 4. In various embodiments, SEP 400 is a secure circuit having tamper resistance. In the illustrated embodiment, SEP 400 implements tamper resistance through the use of filter 410 and secure mailbox 420.

Filter 410 is circuitry configured to tightly control access to SEP 400 to increase the isolation of the SEP 400 from the rest of a device 100A, and thus the overall security of device 100A. More particularly, in some embodiments, filter 410 may permit read/write operations from processor 102 (or other coupled peripherals coupled to interconnect 402 in some embodiments) to enter SEP 400 only if the operations address the secure mailbox 420. Other operations may not progress from the interconnect 402 into SEP 400. Even more particularly, filter 410 may permit write operations to the address assigned to the inbox portion of secure mailbox 420 and read operations to the address assigned to the outbox portion of the secure mailbox 420. All other read/write operations may be prevented/filtered by filter 410. In some embodiments, filter 410 may respond to other read/write operations with an error. In one embodiment, filter 410 may sink write data associated with a filtered write operation without passing the write data on to local interconnect 470. In one embodiment, filter 410 may supply nonce data as read data for a filtered read operation. Nonce data (e.g., “garbage data”) may generally be data that is not associated with the addressed resource within the SEP 400. Filter 410 may supply any data as nonce data (e.g., all zeros, all ones, random data from a random number generator, data programmed into filter 410 to respond as read data, the address of the read transaction, etc.). Thus, filter 410 may prevent direct access to internal components 430-470 by an external entity such as processor 102. In various embodiments, filter 410 may only filter incoming read/write operations. Thus, the components of the SEP 400 may have full access to the other components of computing device 100. Accordingly, filter 410 may not filter responses from interconnect 402 that are provided in response to read/write operations issued by SEP 400.

Secure mailbox 420 is circuitry that, in some embodiments, includes an inbox and an outbox. Both the inbox and the outbox may be first-in, first-out buffers (FIFOs) for data. The buffers may have any size (e.g., any number of entries, where each entry is capable of storing data from a read/write operation). Particularly, the inbox may be configured to store write data from write operations sourced from interconnect 402. The outbox may store write data from write operations sourced by processor 430. (As used herein, a “mailbox mechanism” refers to a memory circuit that temporarily stores 1) an input for a secure circuit until it can be retrieved by the circuit and/or 2) an output of a secure circuit until it can be retrieved by an external circuit.)

In some embodiments, software executing on processor 102, such as application 110, (or other peripherals coupled to interconnect 402) may request services of SEP 400 via an application programming interface (API) supported by an operating system of device 100—i.e., a requester may make API calls that request services of SEP 400. These calls may cause corresponding requests to be written to mailbox mechanism 420, which are then retrieved from mailbox 420 and analyzed by processor 430 to determine whether it should service the requests. Accordingly, this API may be used to send requests to SEP 400 via mailbox 420, including a key generation request generated at step 206, which initiates a cryptographic key pair generation within cryptographic circuit 120. This API may be used to supply initiating system certificate supplied at step 220, which allows SEP 400 to receive and validate a certificate received at step 220 as part of the registration exchange 200. This API may be used by processor 102 to send a request at step 222 for shared secret 122, which triggers SEP 400 to derive a shared secret 122 using stored key material 132 and a certificate received at step 220. Additionally, key material, which may be received from another device 100A participating in key exchange, a sensitive data object for encryption or decryption, or biometric data may also be transmitted via mailbox 420. By isolating SEP 400 in this manner, the security of SEP 400 may be enhanced, preventing potential malicious processes running on processor 102 from extracting sensitive cryptographic materials such as key material 132, shared secret 122, or biometric data 462.

SEP processor 430 is configured to process commands received from various sources in computing device 100 and may use various secure peripherals to accomplish the commands. Processor 430 may then execute instructions stored in ROM 440 (or elsewhere such as in memory 104) such as manager 442, which may use components of SEP 400 to facilitate performing various actions described above with respect to shared secret 122. For example, in response to receiving a shared secret request at step 222, SEP processor 430 may execute manager 442 to provide appropriate commands to notify cryptographic circuit 120 of the received request. Manager 442 may also interact with other components of SEP 400, such as biosensor pipeline 460 if, for example, use of key material 132 or shared secret 122 is predicated on a successful biometric authentication of a user of device 100A.

Secure ROM 440 is a memory configured to store program instruction for booting SEP 400. In some embodiments, ROM 440 may respond to only a specific address range assigned to secure ROM 440 on local interconnect 470. The address range may be hardwired, and processor 430 may be hardwired to fetch from the address range at boot in order to boot from secure ROM 440. Filter 410 may filter addresses within the address range assigned to secure ROM 440 (as mentioned above), preventing access to secure ROM 440 from components external to the SEP 400. In some embodiments, secure ROM 440 may include other software executed by SEP processor 430 during use. This software may include the program instructions of manager 442 to process inbox messages and generate outbox messages, etc. In some embodiments, program instructions executed by SEP processor 430 are signed by a trusted authority (e.g., devices 100A’s manufacturer) in order to ensure their integrity. These program instructions may include those stored in secure ROM 440 and program instructions stored externally such as in memory 104; however, these externally stored program instructions may have their signatures verified by program instructions in ROM 440 prior to being permitted to be executed by processor 430.

Biosensor sensor pipeline 460, in various embodiments, is circuitry configured to authenticate a user by comparing biometric data captured by a biosensor of device 100A from a user being authenticated with a biometric data 462 of an authorized user, which may be stored in memory 104 or elsewhere. As used herein, “biometric data” refers to data that uniquely identifies the user among other humans (at least to a high degree of accuracy) based on the user’s physical or behavioral characteristics. In some embodiments, the biosensor is a camera configured to collect facial data of a user’s face (or eyes) in order to perform facial recognition (or iris recognition). In other embodiments, the biosensor may be configured to collect other forms of biometric data such voice recognition data, fingerprint data, vein data, etc. In some embodiments, pipeline 460 may perform the comparison using a collection of neural networks included in pipeline 460, each network being configured to compare biometric data captured in a single frame with biometric data captured in multiple frames for an authorized user. As shown, pipeline 460 may be configured to read, from memory 104, biometric data 462, which may be protected by encryption in some embodiments and/or be stored in an associated part of memory 104 that is only accessible to SEP 400. (In another embodiment, SEP 400 may store biometric data 462 internally.) Based on the comparison of biometric data 462, pipeline 460 may provide an authentication result/confirmation indicating whether the authentication was successful or failed.

Various components of SEP 400 may facilitate cryptographic circuit 120’s generation of shared secret 122 and help improve the security of circuit 120.

Turning now to FIG. 5, a block diagram of components within cryptographic circuit 120 is depicted. As shown, cryptographic circuit 120 may include a sequencer 510, public key accelerator (PKA) intellectual property (IP) 520, PKA ROM 530, NVM 540, fuses 550, random number generator (RNG) IP 560, and hash IP 570 connected using interconnect 580. In the illustrated embodiment, secure memory 130 includes PKA ROM 530, NVM 540, and fuses 550. In other embodiments, circuit 120 may be implemented differently and include more (or less) components—e.g., RNG IP 560 and hash IP 570 may be external to circuit 120 but included in SEP 400, secure memory 130 may not include fuses 550, etc.

Sequencer 510 is circuitry configured to decode commands received from SEP processor 430 and generate a series of subcommands/program instructions for PKA IP 520 (or other components in cryptographic circuit 120) to implement the commands. For example, these commands may include ones to generate key pairs associated with key material 132, encrypt or decrypt data using key pairs, sign data, verify data, implement ECDH, etc. They may also include commands to generate random numbers and hash values for RNG IP 560 and hash IP 570. In the illustrated embodiment, sequencer 510 accesses PKA ROM 530 to retrieve subcommands to provide to components in cryptographic circuit 120. In some embodiments, sequence 510 may employ logic and/or program instructions stored PKA ROM 530 to decode received commands and issue corresponding subcommands.

PKA IP 520 is circuitry configured to perform various public key cryptographic operations with respect to private key material 132. Accordingly, PKA IP 520 may include logic to implement Rivest Shamir Adleman (RSA), Digital Signature Algorithm (DSA), elliptic curve cryptography (ECC), etc. Although described as a public key accelerator, IP 520 may support other cryptographic algorithms such as those noted above. In some embodiments, PKA IP 520 may be the only circuitry able to access key material 132 in secure memory 130—and thus derive shared secret 122 using key material 132. PKA IP 520 may also interact with other components in cryptographic circuit 120 such as RNG IP 560 and hash IP 570 in order to implement various actions such as key and signature generation, signature validation, etc.

PKA ROM 530 is a ROM configured to store immutable program instructions 532 executable by components of cryptographic circuit 120 to perform the various operations described herein with respect to circuit 120. In various embodiments, these instructions are stored in ROM 530 during fabrication—and thus known to be trustworthy. During fabrication, ROM 530 may also be provisioned with static data used by circuit 120. As noted above, by storing program instructions 532 and data in ROM 530 to make them immutable, the security of cryptographic circuit 120 (and thus shared secret 122) is improved.

NVM 540 is a non-volatile memory configured to store various intermediate results generated by PKA IP 520 during operation. In the illustrated embodiment, the results include and components of key material 132 and shared secret 122. NVM 540 may also include a certificate received at step 220 from initiating system 100B, etc. To further enhance security, cryptographic circuit 120 may execute a sequence of program instructions in a particular order to perform the key exchange and prevent out of order execution of the sequence by clearing portions of the secure memory between executing instructions in order to prevent instructions executed out of order from influencing subsequently executed instructions. For example, zeros (or some other default value) may be written, in response to receiving a given program instruction in the sequence, to a portion of the secure memory used by the next program instruction in the particular order.

Fuses 550 is a fuse bank configured to store key material usable by cryptographic circuit 120, which may be used to initially generate key material 132 or generate the signed attestation key pair used to attest to key material 132. In the illustrated embodiment, this key material includes a unique identifier (UID) 552 that uniquely identifies device 100A from other devices. This key material may also include a generation identifier (GID) unique to a particular generation of devices, etc. These values may be recorded at fabrication of device 100A by burning various ones of fuses 550. In various embodiments, fuses 550 are inaccessible to components external to cryptographic circuit 120 (or external to SEP 400) such as processor 102.

RNG IP 560 is circuity configured to generate random numbers for use by various components in cryptographic circuit 120. Accordingly, RNG IP 560 may provide a random value to PKA IP 520 for storage in NVM 540 as a portion of key material 132. Although RNG IP 560 may, in some embodiments, implement a pseudo-random number generator, RNG IP 560, in other embodiments, implements a truly random number generator that uses external sources of randomness such as measured temperatures, etc. In various embodiments, RNG IP 560 is inaccessible to components external to SEP 400 such as processor 102.

Hash IP 570 is circuitry configured to implement any suitable hash algorithm such as secure hash algorithms (SHA), hash-based message authentication code (HMAC), etc., which may be used by components in SEP 400. Accordingly, hash IP 570 may generate hash values that are encrypted/signed by PKA IP 520—or compared in signature verifications by PKA IP 520.

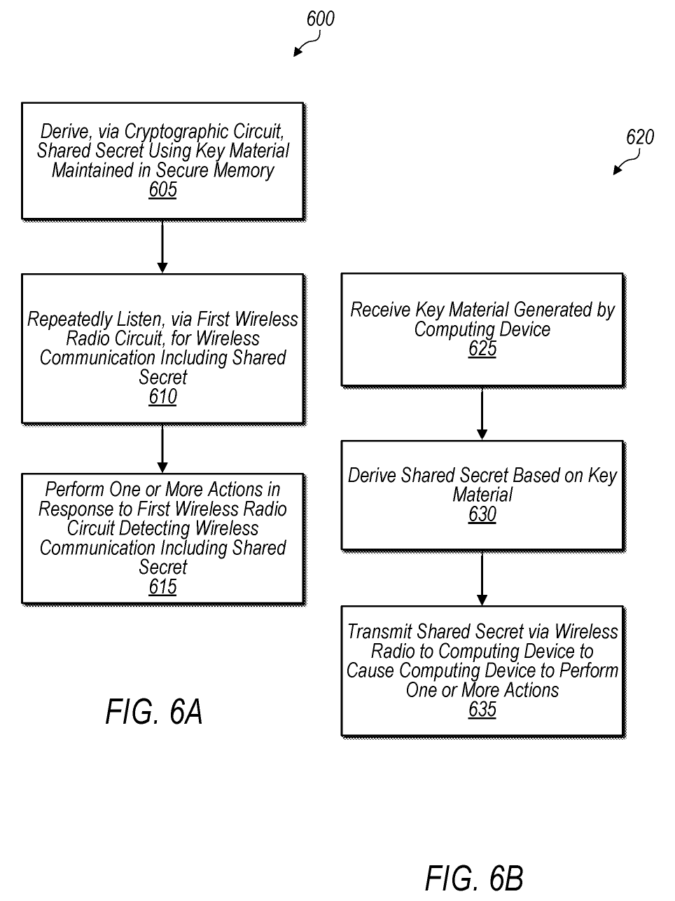

Turning now to FIG. 6A, a flow diagram of a method 600. Method 600 is one embodiment of a method that is performed by a computing system that implements a wireless communication with a shared secret. In various embodiments, method 600 may be performed by executing program instructions stored on a non-transitory computer-readable storage medium. In some embodiments, method 600 includes more or fewer steps than shown.

Method 600 begins in step 605 with the computing system deriving, via a cryptographic circuit, a shared secret using key material maintained in the secure memory. For example, cryptographic circuit 120 of device 100A may derive the shared secret 122 using key material 132 stored in secure memory 130. The derivation process may involve performing a cryptographic key exchange, such as an Elliptic-curve Diffie-Hellman (ECDH) exchange, using a private key maintained in secure memory 130 and a public key received from initiating system 100B.

In step 610 the computing system repeatedly listens, via a first wireless radio circuit. for a wireless communication including the shared secret. For example, wireless radio(s) 140 of device 100A may periodically activate to detect wireless communication 142, which includes the shared secret, from initiating system 100B. The wireless radio(s) 140 may operate in a low-power state until a valid shared secret is detected, at which point the computing system may initiate further authenticated communication.

In step 615, the computing system performs one or more actions in response to the first wireless radio circuit detecting the wireless communication including the shared secret. For example, memory 104 of device 100A may store program instructions that, upon detection of wireless communication 142 containing the shared secret, trigger an authenticated operation such as downloading a software update, retrieving a message, or establishing a secure connection with initiating system 100B. These actions ensure that only authorized communications initiate sensitive operations on the computing device.

In some embodiments, the first wireless radio circuit is further configured to periodically listen for the wireless communication while the processor is in a reduced power state in which execution of the program instructions by the processor is suspended and in response to detecting the shared secret in the wireless communication, cause the processor to exit the reduced power state and initiate execution of the program instructions. For example, wireless radio(s) 140 may periodically wake from a low-power mode to scan for wireless communication 142 containing the shared secret. If the shared secret is detected, wireless radio(s) 140 may generate a wake signal that transitions processor 102 from a reduced power state to an active state, allowing execution of the program instructions to proceed. This configuration enables device 100A to conserve power while remaining responsive to authorized wireless communications. In some embodiments, the first wireless radio circuit is further configured to periodically listen for the wireless communication while the computing device appears to be powered off. For example, wireless radio(s) 140 may remain active in a low-power state, periodically scanning for wireless communication 142 even when device 100A appears powered off. In some embodiments, the first wireless radio circuit is further configured to periodically listen for the wireless communication prior to any user being associated with the computing device and after a user has been associated with the computing device, discontinue listening for the wireless communication. For example, wireless radio(s) 140 may periodically listen for wireless communication 142 while device 100A is in an unassociated state, such as during initial provisioning or prior to user activation, and upon detecting user association, disable further listening to prevent unnecessary power consumption or unauthorized access. In some embodiments, the first wireless radio circuit is further configured to periodically listen for the wireless communication while the computing device is operating on battery power. For example, wireless radio(s) 140 may continue to periodically listen for wireless communication 142 even when device 100A is operating solely on battery power, allowing it to receive secure provisioning commands or updates without requiring a wired power connection.

In some embodiments, the one or more actions include downloading a software update from an external system and installing the software update on the computing device. For example, device 100A may use wireless radio(s) 140 to establish authenticated communication 302 with external system 330, retrieve a software update, and install the update to ensure that the device is running the latest firmware or security patches before user activation. In some embodiments, the one or more actions include downloading a message from aa external system and displaying the message on the computing device after a user interacts with the computing device. For example, device 100A may use wireless radio(s) 140 to establish authenticated communication 302 with external system 330, retrieve a message intended for the user, and store it in memory 104. Upon user interaction, such as powering on the device or unlocking the screen, the message may be displayed to provide important notifications or instructions. In some embodiments, the one or more actions include establishing a secure communication with an external system using the key material. For example, device 100A may use wireless radio(s) 140 to initiate authenticated communication 302 with external system 330, leveraging shared secret 122 derived by cryptographic circuit 120 to establish a secure channel. This secure communication may be used for exchanging encrypted data, verifying device identity, or retrieving provisioning information.

In some embodiments, the first wireless radio circuit comprises a Bluetooth Low Energy (BTLE) transceiver. For example, wireless radio(s) 140 may include a Bluetooth Low Energy (BTLE) transceiver that periodically listens for wireless communication 142, enabling device 100A to detect and respond to provisioning signals, authentication requests, or software update triggers from initiating system 100B. In some embodiments, the computing system further comprises a second wireless radio circuit configured to communicate via a different wireless protocol than the first wireless radio circuit wherein the program instructions are further executable to perform the one or more actions using the second wireless radio circuit. For example, wireless radio(s) 140 may include a second wireless radio circuit, such as a Wi-Fi or cellular transceiver, that operates independently of the first wireless radio circuit. This second wireless radio circuit may be used to download a software update, retrieve a message, or establish a secure communication with an external system after the first wireless radio circuit detects a provisioning signal or authentication request.

In some embodiments, the cryptographic circuit is further configured to generate a public key pair during a manufacturing process of the computing device, wherein the key material includes a private key of the public key pair. For example, during the manufacturing process of device 100A, cryptographic circuit 120 may generate a public-private key pair and securely store the private key in secure memory 130. This private key remains inaccessible to processor 102 and other external components, ensuring that cryptographic operations, such as deriving a shared secret or generating attestations, are securely performed within cryptographic circuit 120. In some embodiments, the program instructions are further executable to register the public key pair with a computing system by causing the cryptographic circuit to sign an attestation that includes a public key of the public key pair and sending the attestation to the computing system. For example, processor 102 may execute program instructions to request cryptographic circuit 120 to generate a signed attestation for the public key pair, where the attestation includes the public key and a digital signature generated using a secure signing key stored in cryptographic circuit 120. The attestation is then transmitted to initiating system 100B as part of registration exchange 200, enabling the computing system to verify the authenticity of the public key and associate it with device 100A. In some embodiments, the program instructions are further executable to in response to a verification of the signed attestation, receiving a corresponding certificate that includes the public key. For example, after transmitting the signed attestation to initiating system 100B as part of registration exchange 200, processor 102 may receive a device certificate that includes the public key. Initiating system 100B verifies the signed attestation, ensuring that the public key was securely generated and is associated with device 100A, and issues the corresponding certificate, which is then stored for future authentication and secure communications.

Turning now to FIG. 6B, a flow diagram of a method 620. Method 620 is one embodiment of a method that is performed by a computing system that implements a wireless communication with a shared secret. In various embodiments, method 620 may be performed by executing program instructions stored on a non-transitory computer-readable storage medium. In some embodiments, method 620 includes more or fewer steps than shown.

Method 620 begins in step 625 with the computing system receiving key material generated by a computing device, wherein the key material is created during a manufacturing process of the computing device and stored in a secure memory of the computing device. For example, initiating system 100B may receive key material associated with device 100A during a provisioning or registration process. This key material, generated and stored in secure memory of device 100A during manufacturing, may be used to establish a cryptographic trust relationship between device 100A and initiating system 100B, ensuring secure communication and authentication.

In step 630, the computing system derives a shared secret based on the key material. For example, initiating system 100B may use the received key material along with its own cryptographic data to perform an Elliptic-curve Diffie-Hellman (ECDH) key exchange, deriving a shared secret that will be used to securely communicate with device 100A. This shared secret ensures that subsequent communications between initiating system 100B and device 100A are encrypted and authenticated.

In step 635, the computing system transmits the shared secret via a wireless radio to the computing device to cause the computing device to perform one or more actions. For example, initiating system 100B may transmit the shared secret to device 100A using a wireless protocol such as Bluetooth Low Energy (BTLE) or another short-range communication method. The shared secret may be embedded in a provisioning signal, triggering device 100A to authenticate the communication and perform one or more actions, such as downloading a software update, retrieving a configuration message, or initiating a secure connection with an external system.

In some embodiments, the one or more actions include downloading, via the computing device, a software update and installing the software update on the computing device. For example, upon receiving the shared secret from initiating system 100B, device 100A may authenticate the communication and establish a secure connection with an external system 330. Using this connection, device 100A may download a software update and install it to ensure that the device operates with the latest security patches, firmware, or system enhancements before user activation. In some embodiments, the receiving and deriving are performed by a registration system of the computing system, and wherein the transmitting is performed by a device of the computing system that is co-located with the computing device. For example, registration system 310 of initiating system 100B may receive key material from device 100A and derive a shared secret based on this key material. Once the shared secret is established, a local device 320, which is physically co-located with device 100A (e.g., a technician’s computer or provisioning station), may transmit the shared secret via wireless communication to facilitate secure provisioning, authentication, or software updates.

### Exemplary Computer System

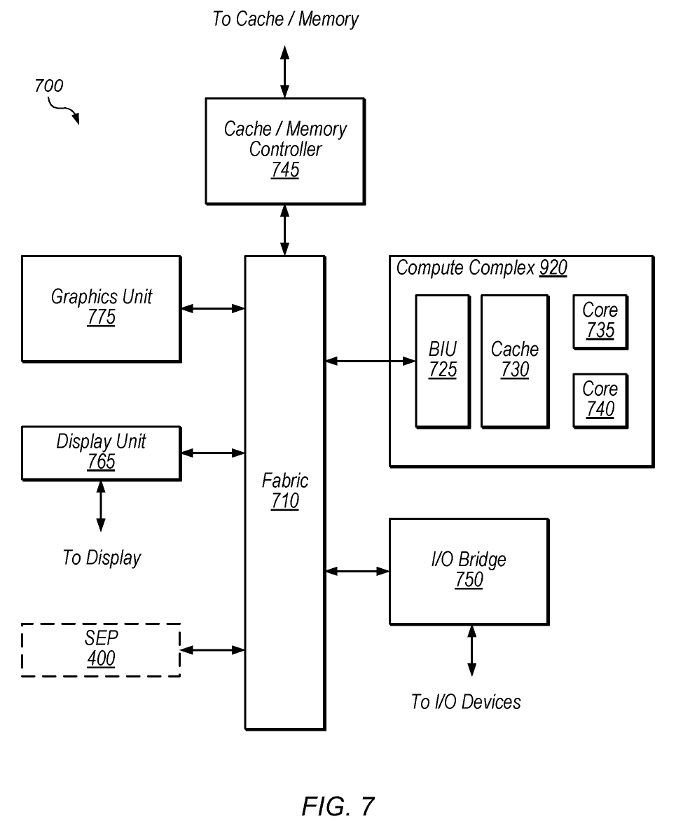

Turning now to FIG. 7, a block diagram illustrating an example embodiment of a device 700 is shown. In some embodiments device 700 may implement functionality of one or both devices 100A and 100B. In some embodiments, elements of device 700 may be included within a system on a chip. In some embodiments, device 700 may be included in a mobile computing device, which may be battery powered. Therefore, power consumption by device 700 may be an important design consideration. In the illustrated embodiment, device 700 includes fabric 710, compute complex 720 input/output (I/O) bridge 760, cache/memory controller 730, graphics unit 740, and display unit 750. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX’s, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 722, cache 724, and cores 726A-B. In various embodiments, compute complex 720 may include various numbers of processors, processor cores and caches. For example, compute complex 720 may include 1, 2, or 4 processor cores, or any other suitable number. In one embodiment, cache 724 is a set associative L2 cache. In some embodiments, cores 726A-B may include internal instruction and data caches. In some embodiments, a coherency unit (not shown) in fabric 710, cache 724, or elsewhere in device 700 may be configured to maintain coherency between various caches of device 700. BIU 722 may be configured to manage communication between compute complex 720 and other elements of device 700. Processor cores such as cores 726A-B may be configured to execute instructions of a particular instruction set architecture (ISA) which may include operating system instructions and user application instructions. These instructions may be stored in computer readable medium such as a memory coupled to memory controller 730 discussed below.

As used herein, the term “coupled to” may indicate one or more connections between elements, and a coupling may include intervening elements. For example, in FIG. 7, graphics unit 740 may be described as “coupled to” a memory through fabric 710 and cache/memory controller 730. In contrast, in the illustrated embodiment of FIG. 7, graphics unit 740 is “directly coupled” to fabric 710 because there are no intervening elements.

Cache/memory controller 730 may be configured to manage transfer of data between fabric 710 and one or more caches and memories. For example, cache/memory controller 730 may be coupled to an L3 cache, which may in turn be coupled to a system memory. In other embodiments, cache/memory controller 730 may be directly coupled to a memory. In some embodiments, cache/memory controller 730 may include one or more internal caches. Memory coupled to controller 730 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 730 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions, such as those of application 110, executable by compute complex 720 to cause device 700 to perform functionality described herein.

Graphics unit 740 may include one or more processors, e.g., one or more graphics processing units (GPUs). Graphics unit 740 may receive graphics-oriented instructions, such as OPENGL^{®}, Metal^{®}, or DIRECT3D^{®} instructions, for example. Graphics unit 740 may execute specialized GPU instructions or perform other operations based on the received graphics-oriented instructions. Graphics unit 740 may generally be configured to process large blocks of data in parallel and may build images in a frame buffer for output to a display, which may be included in the device or may be a separate device. Graphics unit 740 may include transform, lighting, triangle, and rendering engines in one or more graphics processing pipelines. Graphics unit 740 may output pixel information for display images. Graphics unit 740, in various embodiments, may include programmable shader circuitry which may include highly parallel execution cores configured to execute graphics programs, which may include pixel tasks, vertex tasks, and compute tasks (which may or may not be graphics-related).

Display unit 750 may be configured to read data from a frame buffer and provide a stream of pixel values for display. Display unit 750 may be configured as a display pipeline in some embodiments. Additionally, display unit 750 may be configured to blend multiple frames to produce an output frame. Further, display unit 750 may include one or more interfaces (e.g., MIPI® or embedded display port (eDP)) for coupling to a user display (e.g., a touchscreen or an external display).

I/O bridge 760 may include various elements configured to implement: universal serial bus (USB) communications, security, audio, and low-power always-on functionality, for example. I/O bridge 760 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 760.

In some embodiments, device 700 includes network interface circuitry (not explicitly shown), which may be connected to fabric 710 or I/O bridge 760. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 700 with connectivity to various types of other devices and networks.

### Example Applications

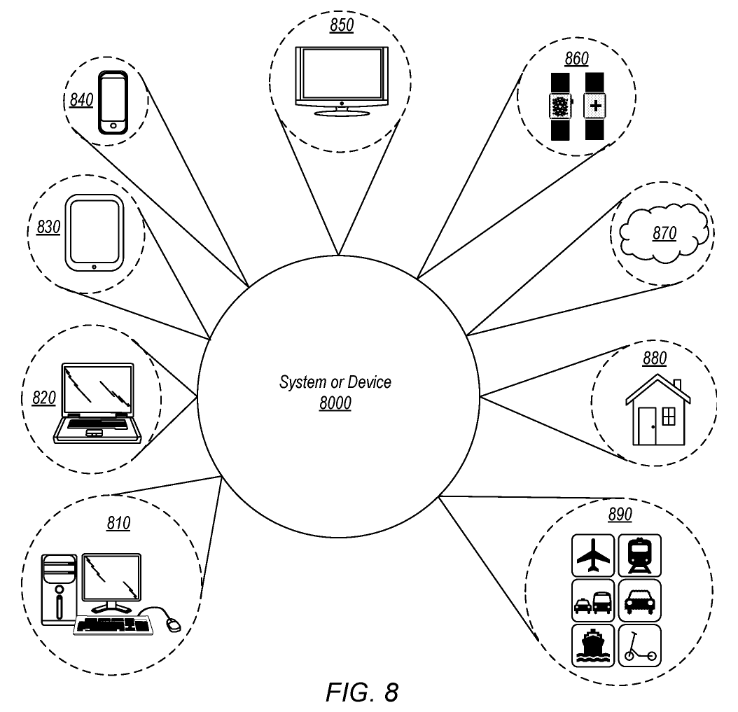

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user’s vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

### Example Computer-readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a computing system configured to generate a simulation model of the hardware circuit, by a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

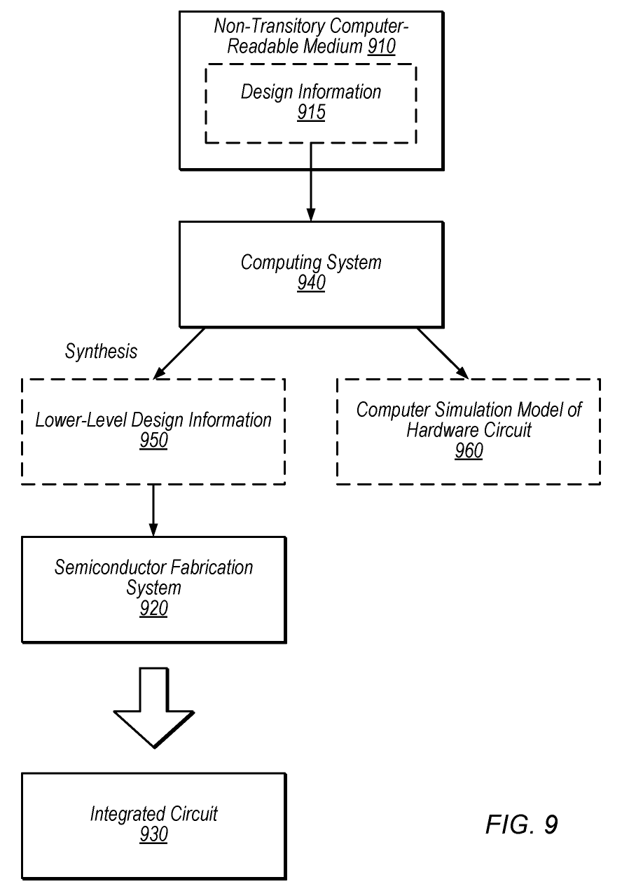

Turning now to FIG. 9, a block diagram of an example non-transitory computer-readable storage medium that stores circuit design information is depicted. In the illustrated embodiment, computing system 940 is configured to process the design information. This may include executing instructions included in the design information, interpreting instructions included in the design information, compiling, transforming, or otherwise updating the design information, etc. Therefore, the design information controls computing system 940 (e.g., by programming computing system 940) to perform various operations discussed below, in some embodiments.

In the illustrated example, computing system 940 processes the design information to generate both a computer simulation model of a hardware circuit 960 and lower-level design information 950. In other embodiments, computing system 940 may generate only one of these outputs, may generate other outputs based on the design information, or both. Regarding the computing simulation, computing system 940 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 940 also processes the design information to generate lower-level design information 950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 950 (potentially among other inputs), semiconductor fabrication system 920 is configured to fabricate an integrated circuit 930 (which may correspond to functionality of the simulation model 960). Note that computing system 940 may generate different simulation models based on design information at various levels of description, including information 950, 915, and so on. The data representing design information 950 and model 960 may be stored on medium 910 or on one or more other media.

In some embodiments, the lower-level design information 950 controls (e.g., programs) the semiconductor fabrication system 920 to fabricate the integrated circuit 930. Thus, when processed by the fabrication system, the design information may program the fabrication system to fabricate a circuit that includes various circuitry disclosed herein.

Non-transitory computer-readable storage medium 910, may comprise any of various appropriate types of memory devices or storage devices. Non-transitory computer-readable storage medium 910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 910 may include other types of non-transitory memory as well or combinations thereof. Accordingly, non-transitory computer-readable storage medium 910 may include two or more memory media; such media may reside in different locations—for example, in different computer systems that are connected over a network.

Design information 915 may be specified using any of various appropriate computer languages, including hardware description languages such as, without limitation: VHDL, Verilog, SystemC, SystemVerilog, RHDL, M, MyHDL, etc. The format of various design information may be recognized by one or more applications executed by computing system 940, semiconductor fabrication system 920, or both. In some embodiments, design information may also include one or more cell libraries that specify the synthesis, layout, or both of integrated circuit 930. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 930 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 and model 960 are configured to operate according to a circuit design specified by design information 915, which may include performing any of the functionality described herein. For example, integrated circuit 930 may include any of various elements shown in FIGS. 1-5. Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to …” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 920 to fabricate integrated circuit 930.

***

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

***

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

***

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A computing device, comprising:
a processor;
a cryptographic circuit coupled to a secure memory inaccessible to the processor, wherein the cryptographic circuit is configured to:
derive a shared secret using key material maintained in the secure memory;
a first wireless radio circuit configured to:
repeatedly listen for a wireless communication including the shared secret; and
memory accessible to the processor and having program instructions stored therein that are executable by the processor to:
perform one or more actions in response to the first wireless radio circuit detecting the wireless communication including the shared secret.

2. The computing device of claim 1, wherein the first wireless radio circuit is further configured to:
listen for the wireless communication while the processor is in a reduced power state in which execution of the program instructions by the processor is suspended; and
in response to detecting the shared secret in the wireless communication, cause the processor to exit the reduced power state and initiate execution of the program instructions.

3. The computing device of claim 2, wherein the first wireless radio circuit is further configured to:
listen for the wireless communication while a display of the computing device is powered off.

4. The computing device of claim 1, wherein the first wireless radio circuit is further configured to:
listen for the wireless communication prior to any user being associated with the computing device; and
after a user has been associated with the computing device, discontinue listening for the wireless communication.

5. The computing device of claim 1, wherein the first wireless radio circuit is further configured to:
listen for the wireless communication while the computing device is operating on battery power.

6. The computing device of claim 1, wherein the one or more actions include:
downloading a software update from an external system; and
installing the software update on the computing device.

7. The computing device of claim 1, wherein the one or more actions include:
downloading a message from an external system; and
displaying the message on the computing device after a user interacts with the computing device.

8. The computing device of claim 1, wherein the one or more actions include:
establishing a secure communication with an external system using the key material.

9. The computing device of claim 1, wherein the first wireless radio circuit comprises a Bluetooth Low Energy (BTLE) transceiver.

10. The computing device of claim 1, further comprising:
a second wireless radio circuit configured to:
communicate via a different wireless protocol than the first wireless radio circuit; and
wherein the program instructions are further executable to:
perform the one or more actions using the second wireless radio circuit.

11. The computing device of claim 10, wherein the second wireless radio circuit comprises a Wi-Fi transceiver or a cellular transceiver.

12. The computing device of claim 1, wherein the cryptographic circuit is further configured to:
generate a public key pair during a manufacturing process of the computing device, wherein the key material includes a private key of the public key pair.

13. The computing device of claim 12, wherein the program instructions are further executable to:
register the public key pair with a computing system by causing the cryptographic circuit to sign an attestation that includes a public key of the public key pair and sending the attestation to the computing system.

14. The computing device of claim 13, wherein the program instructions are further executable to:
in response to a verification of the signed attestation, receiving a corresponding certificate that includes the public key.

15. The computing device of claim 12, wherein the program instructions are further executable to:
receive a certificate associated with a sender of the wireless communication, wherein the certificate includes a public key associated with the sender; and
provide, to the cryptographic circuit, the public key associated with the sender to enable the cryptographic circuit to derive the shared secret based on the public key associated with the sender and the private key of the generated public key pair.

16. The computing device of claim 15, wherein the cryptographic circuit is configured to:
perform elliptic-curve Diffie–Hellman (ECHD) to derive the shared secret based on the public key associated with the sender and the private key of the generated public key pair.

17. A method, comprising:
deriving, by a cryptographic circuit of a computing device, a shared secret using derivation material maintained in a secure memory accessible to the cryptographic circuit and inaccessible to a processor of the computing device;
repeatedly, by a first wireless radio circuit of the computing device and while the processor is in a reduced power state in which execution of program instructions by the processor is suspended, listening for a wireless communication including the shared secret; and
performing, by the processor of the computing device, one or more actions in response to the first wireless radio circuit detecting the wireless communication including the shared secret.

18. A method, comprising:
receiving, by a computing system, key material generated by a computing device, wherein the key material is generated a cryptographic circuit of the computing device during a registration process and stored in a secure memory accessible to the cryptographic circuit;
deriving, by the computing system, a shared secret based on the key material; and
transmitting, by a computing system, the shared secret via a wireless radio to the computing device to cause the computing device to perform one or more actions, wherein the computing device is configured to detect transmission of the shared secret using the key material stored in the secure memory.

19. The method of claim 18, wherein the receiving and deriving are performed by a registration system of the computing system during a manufacturing process of the computing device; and
wherein the transmitting is performed by a device of the computing system that is co-located with the computing device.

20. The method of claim 18, wherein the shared secret is transmitted within Bluetooth Low Energy (BTLE) beacon.
